(19) United States
(12) Patent Application Publication
(10) Pub. No.: US 2010/0043631 A1
(43) Pub. Date: Feb. 25, 2010

(54) Compressor with Improved Lubrication

(75) Inventors: David Bruce HAMLIN, Flint, TX (US); John Kenneth WOLLITZ, Tyler, TX (US)

Correspondence Address: CONLEY ROSE, P.C., 5601 GRANITE PARKWAY, SUITE 750, PLANO, TX, 75024, US

(73) Assignee: TRANE INTERNATIONAL, INC., Piscataway, NJ (US)

(21) Appl. No.: 12/195,953

(22) Filed: Aug. 21, 2008

(51) Int. Cl. F04B 39/02; F16J 1/00; F01M 11/00

(52) U.S. Cl. 92/158; 92/172; 184/6.5

(57) ABSTRACT

A compressor for an air conditioning system comprises a piston and a pin. The piston comprises an aperture forming a piston bearing surface and a lubrication port in communication with the aperture. The pin comprises a pin bearing surface and the pin is received within the aperture to form an interface between the pin bearing surface and the piston bearing surface. In another embodiment, a method of lubricating within a compressor comprises rotating a crankshaft within a crankcase, introducing lubricant into the crankcase; and contacting the lubricant with a portion of a pin disposed within a piston via a lubrication port in the piston. In yet another embodiment, a piston for a compressor comprises an aperture forming a piston bearing surface and a lubrication port in communication with the aperture.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

Some conventional refrigeration and/or air conditioning compressors comprise a motor, a crankshaft rotated by the motor, and a reciprocating piston driven by the crankshaft. The reciprocating piston is typically connected to the crankshaft via a connecting arm, which is sometimes also referred to as a “connecting rod” or “con rod.” The connection is made by extending the crankshaft through an aperture in a first end of the connecting arm and extending a pin through apertures in a second end of the connecting arm and the piston, respectively. In operation, the connecting arm moves with respect to both the crankshaft and the pin, and vice versa. Therefore, frictional interfaces are formed where surfaces of the connecting arm engage surfaces of each of the pin and the crankshaft, and these frictional interfaces are typically lubricated.

In some compressors, such as hermetically sealed compressors that conventionally use mineral oil lubricant, for example, splash lubrication is employed whereby the movement of at least the crankshaft and the connecting arm interact with a supply of lubricant, thereby causing the lubricant to splash onto components needing lubrication and sometimes forms a fog or mist within the compressor that also aids in lubricating components. It is not uncommon for there to be some mixing of the lubricants and the refrigerants, such as R-22, within the compressor.

### SUMMARY OF THE DISCLOSURE

A compressor for an air conditioning system is disclosed. In some embodiments, the compressor comprises a piston and a pin. The piston comprises an aperture forming a piston bearing surface and a lubrication port in communication with the aperture. The pin comprises a pin bearing surface and the pin is received within the aperture to form an interface between the pin bearing surface and the piston bearing surface.

In another aspect, the present disclosure relates to methods for lubricating within a compressor, comprising rotating a crankshaft within a crankcase, introducing lubricant into the crankcase, and contacting the lubricant with a portion of a pin disposed within a piston via a lubrication port in the piston.

Further, a piston for a compressor is disclosed. In some embodiments, the piston comprises an aperture forming a piston bearing surface and a lubrication port in communication with the aperture.

### BRIEF DESCRIPTION OF THE DRAWINGS

For a more detailed description of the various embodiments of the compressor with improved lubrication, reference will now be made to the accompanying drawings, wherein:

FIG. 1 is an oblique cut-away view of an embodiment of a compressor employing improved lubrication features and methods;

FIG. 2 is an oblique view of some of the moving parts of the compressor of FIG. 1;

FIG. 3 is a top orthogonal view of a connecting arm of the compressor of FIG. 1;

FIG. 4 is a side orthogonal partial cross-sectional view of a pin of the compressor of FIG. 1;

FIG. 5 is a side orthogonal view of a piston of the compressor of FIG. 1;

FIG. 6 is an oblique view of the piston of FIG. 5; and

FIG. 7 is a bottom orthogonal view of the piston of FIG. 5.

### DETAILED DESCRIPTION

Some refrigerants used in compressors are not amenable to being mixed with mineral oil, so alternative lubricants are used in such compressors. For example, in compressors using the refrigerant R-410A, lubricants such as polyol ester, polyvinylchloride or polyol ester/akylbenzine blends are used instead of mineral oil. These alternative lubricants tend not to splash and/or form a fog or mist as well as mineral oil, and therefore, may not sufficiently lubricate frictional interfaces between moving components. Specifically, the bearing surfaces between the pin and the piston may not be well lubricated through splash lubrication of the polyol ester, polyvinylchloride or polyol ester/akylbenzine blends used with the refrigerant R-410A and/or other refrigerants.

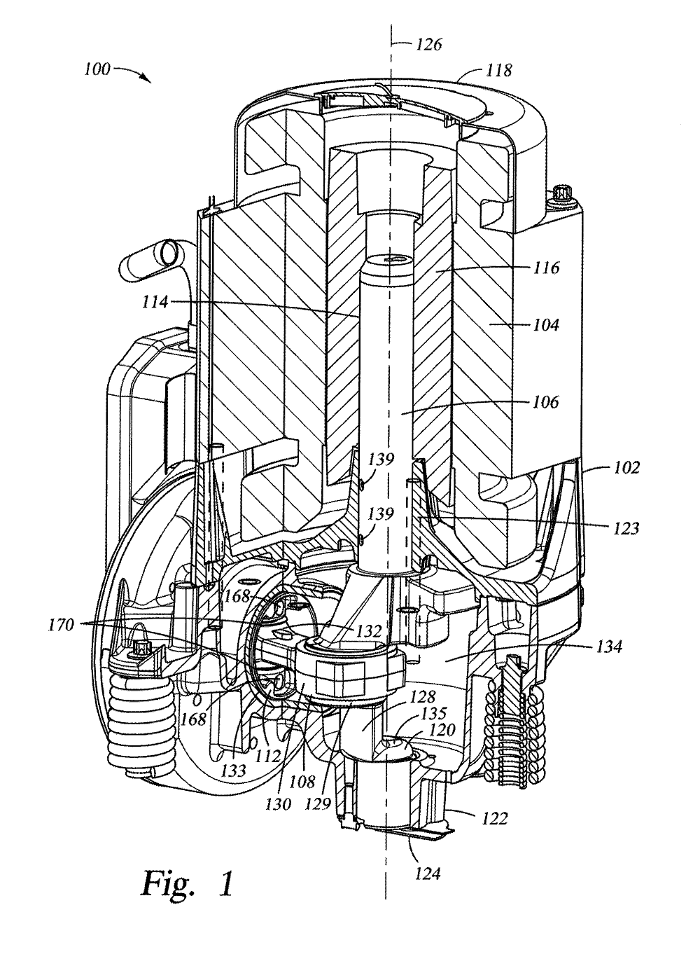

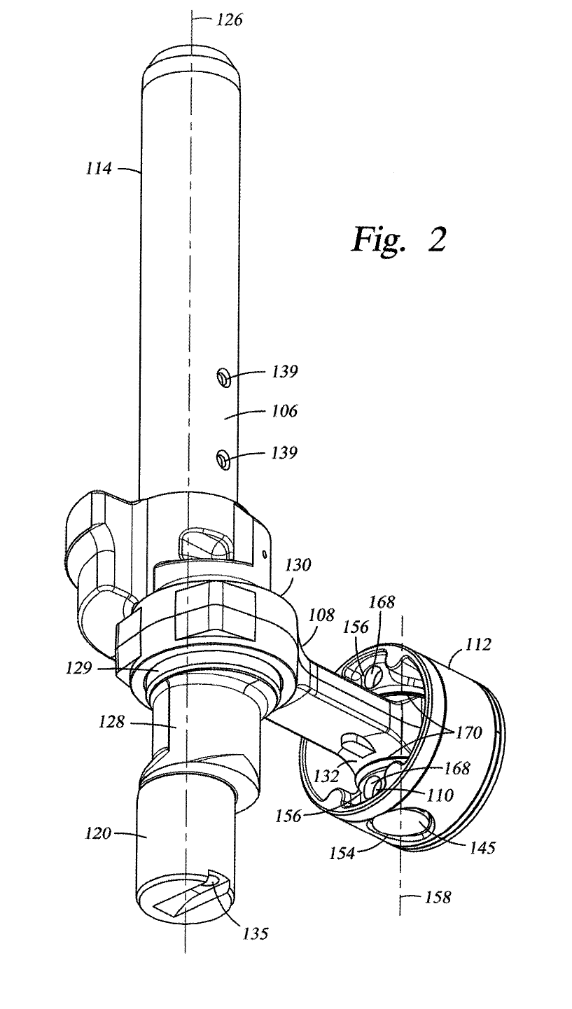

Referring now to FIGS. 1 and 2 in the drawings, an embodiment of a compressor 100 employing improved lubrication features and methods is shown, with FIG. 1 illustrating the compressor 100 more completely and FIG. 2 illustrating only certain moving parts of the compressor 100. The compressor 100 generally comprises an outer housing 102, that may be hermetically sealed, for housing an electrical motor 104, a deviated crankshaft 106, a connecting arm 108, a pin 110 (not visible in FIG. 1), and a piston 112.

An upper shank 114 of the crankshaft 106 is received within an armature 116 of the motor 104 near an upper end 118 of the compressor 100, while a lower shank 120 of the crankshaft 106 is received within a lower bearing 122 near a lower end 124 of the compressor 100. The upper shank 114 and lower shank 120 lie coaxially along an axis of rotation 126 about which the motor 104 rotates the crankshaft 106. The upper shank 114 is also received within an upper bearing 123 that serves to retain the upper shank 114 concentric with the axis of rotation 126 while allowing rotation of the upper shank 114 about the axis of rotation 126. A transition shank 128 is joined between the upper shank 114 and the lower shank 120 and is offset from and generally parallel to the axis of rotation 126.

The connecting arm 108 comprises a shaft ring 130 forming an aperture for receiving and encircling an eccentric bearing surface 129 of the transition shank 128 and a pin ring 132 forming an aperture for receiving and encircling the pin 110 (discussed infra). The eccentric bearing surface 129 is formed substantially as a smooth cylindrical surface with its lengthwise axis oriented generally parallel to the axis of rotation 126. The piston 112 is generally received within a cylindrical bore 133 of the compressor 100 and connected to the pin ring 132 of the connecting arm 108 via the pin 110. The open space within the compressor 100 that generally houses the transition shank 128 and the shaft ring 130, and which extends generally from a top surface of the lower bearing 122 to a top of the upper bearing 123, is referred to as the crankcase 134. During operation, discussed infra, a centrifugal pump (not shown) forces lubricant into the crankcase 134 through a lower lubricant delivery aperture 135 formed longitudinally through the lower shank 120.

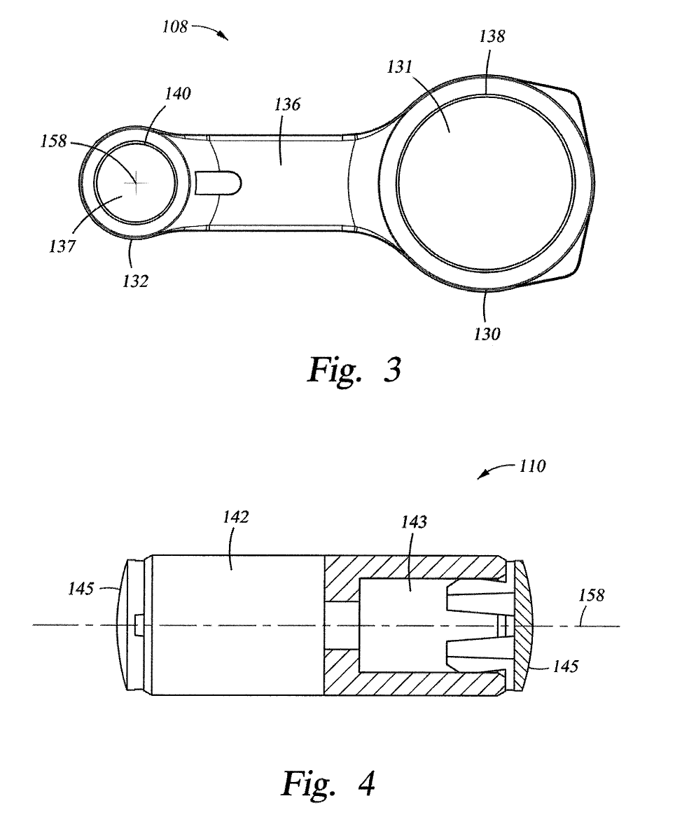

Referring now to FIG. 3, a top orthogonal view of the connecting arm 108 is shown to depict its features in greater detail. The connecting arm 108 further comprises a bridge 136 joining the shaft ring 130 and the pin ring 132. The connecting arm 108 is well suited for alternatingly withstanding high tensile and compressive forces along a path between the shaft ring 130 and the pin ring 132. The shaft ring 130 of the connecting arm 108 comprises an aperture 131 forming a shaft ring bearing surface 138 that is generally smooth for interfacing with the complementary smooth eccentric bearing surface 129 of the crankshaft 106. The shaft ring bearing surface 138 has a smoothness rating sufficient to facilitate movement and minimize friction when the eccentric bearing surface 129 is received within the shaft ring 130 and relative rotation occurs between the eccentric bearing surface 129 and the shaft ring bearing surface 138. In an embodiment, the smoothness rating of the shaft ring bearing surface 138 is 15 microinches Ra. Of course, in alternative embodiments, one or both of the shaft ring 130 and the transition shank 128 may have different smoothness ratings or be outfitted with bearing components, friction reducing coatings or other systems or devices for facilitating relative movement therebetween.

The pin ring 132 of the connecting arm 108 comprises an aperture 137 forming a pin ring bearing surface 140 that is generally smooth for interfacing with a complementary smooth surface of the pin 110. The pin ring bearing surface 140 has a smoothness rating sufficient to facilitate movement and minimize friction when the pin 110 is received within the pin ring 132 and relative rotation occurs. In an embodiment, the smoothness rating of the pin ring bearing surface 140 is 15 microinches Ra. Of course, in alternative embodiments, one or both of the pin ring 132 and the pin 110 may have different smoothness ratings or may be outfitted with bearing components, friction reducing coatings, or other systems or devices for enabling relative movement therebetween.

Referring now to FIG. 4, a side orthogonal view of the pin 110 is shown to depict its features in greater detail. The pin 110 is generally cylindrical in shape and comprises a pin bearing surface 142 that is generally smooth for interfacing with complementary smooth bearing surfaces of the connecting arm 108 and the piston 112. In an embodiment, the pin bearing surface 142 has a smoothness rating of 2 microinches Ra. Of course, in alternative embodiments, the pin bearing surface 142 may have a different smoothness rating. Cavities 143 (only one shown) are located at each end of the generally cylindrical pin 110 and serve to accept endcaps 145. The end caps 145 are inserted into cavities 143, and a portion of each endcap 145 protrudes beyond any portion of the pin bearing surface 142. At least the outermost portions of the endcaps 145 are constructed to have a somewhat smooth surface for providing low friction interfacing with the cylindrical bore 133 of the compressor 100. In an embodiment, the endcaps 145 are constructed of nylon, but in alternative embodiments, the endcaps may be constructed of any other suitable material for preventing binding with the bore 133. In the embodiment shown, the piston 112 is a unitary aluminum die-cast component. However, in alternative embodiments, a piston may be formed by joining two or more piston components, which are substantially similar to the outer wall 144, the pressure cap 150, and the bosses 156, to form the piston. Also, a piston may alternatively be formed using any other suitable manufacturing process or combination of manufacturing processes and the piston may be constructed from a different material or combination of materials.

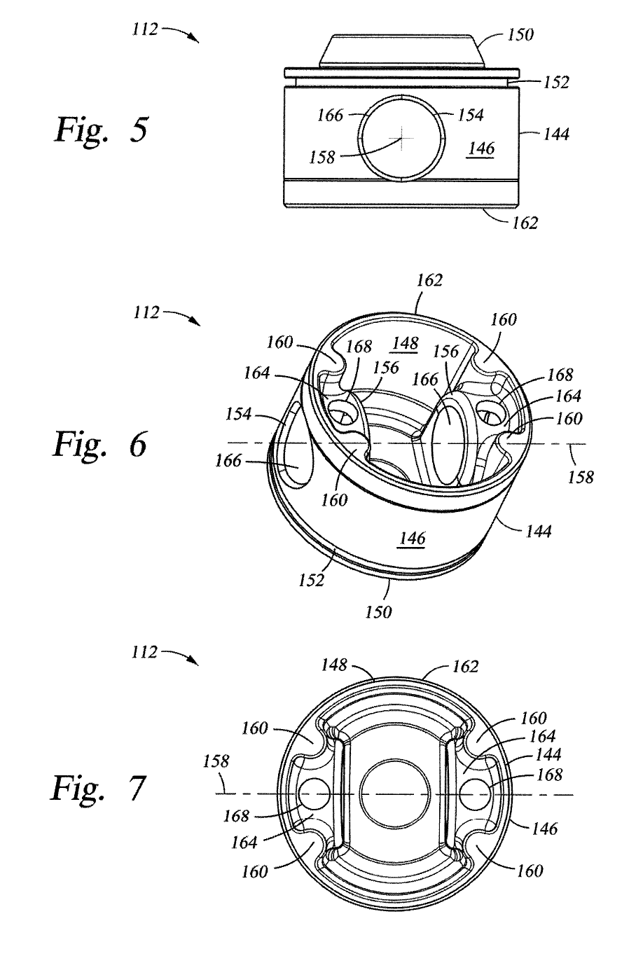

Referring now to FIGS. 5-7, various views of the piston 112 are shown to depict its features in greater detail. The piston 112 generally comprises a cylindrical tubular outer wall 144 having an outer surface 146 and an inner surface 148. One end of the outer wall 144 is sealed by a pressure cap 150 that is generally the leading portion of the piston 112 during a compression stroke of the piston 112 in the bore 133. In other words, the pressure cap 150 leads movement of the piston 112 when the piston 112 moves away from the crankcase 134 of the compressor 100. A ring seat 152, formed as a recessed groove in the outer wall 144, is located near the junction between the outer wall 144 and the pressure cap 150. The ring seat 152 is configured to receive a ring seal (not shown) which, when installed onto the piston 112, is configured to provide a seal between the piston 112 and the cylindrical bore 133 disposed in the compressor, effectively providing a movable pressure partition within the bore 133. In an embodiment, the ring seal may be constructed of cast iron, but in alternative embodiments, the ring seal could be constructed of any other suitable sealing material, such as an elastomer. In an alternative embodiment, the piston does not comprise a ring seat and associated ring seal for providing the pressure partition with the bore, but instead, the outer wall of the piston directly contacts the wall of the bore.

The outer wall 144 is also formed with two opposing pin apertures 154 extending radially therethrough and being sized and shaped for receiving the pin 110. Further, two opposing bosses 156 associated with the pin apertures 154 protrude inward from the inner surface 148 of the outer wall 144 of the piston 112. The bosses 156 serve to strengthen the piston 112 by bolstering its ability to withstand forces exerted on it by the pin 110 while the pin 110 is inserted through the pin apertures 154 along a pin axis of rotation 158. The bosses 156 each comprise two strengthening posts 160 that extend generally from the inside of the pressure cap 150 to an inner end 162 of the piston. In alternative embodiments, a piston may not comprise strengthening posts such as strengthening posts 160. The inner end 162 of the piston 112 is generally the trailing portion of the piston 112 during a compression stroke of the piston 112 in the bore 133. In other words, the inner end 162 trails movement of the piston 112 when the piston 112 moves away from the crankcase 134 of the compressor 100. Between each set of adjacent posts 160, and generally extending inward from the inner surface 148 toward a center of the piston 112, each boss 156 further comprises an annular wall 164 that joins with the respective pin apertures 154 to form piston bearing surfaces 166 that extend along the pin axis of rotation 158. The piston bearing surfaces 166 are generally smooth for interfacing with the smooth pin bearing surface 142 of the pin 110. In an embodiment, the piston bearing surfaces 166 have a smoothness rating of 17 microinches Ra. Of course, in alternative embodiments, the piston bearing surfaces 166 may have a different smoothness rating.

Lubrication ports 168 extend axially through each annular wall 164 of the bosses 156 and communicate with the pin apertures 154 extending radially through the piston outer wall 144. In various embodiments, the lubrication ports 168 may be formed as cylindrical apertures or slots that are cast, milled, drilled or machined into the annular walls 164. As best shown in FIG. 1, the lubrication ports 168 are disposed closest to the crankcase 134 when the piston 112 is installed in the cylindrical bore 133 of the compressor 100. As such, the connection between the lubrication ports 168 and the pin apertures 154 thereby creates a fluid path from the crankcase 134 to the interior of the bosses 156. Thus, lubricant can contact both the pin bearing surfaces 142 that extend through the bosses 156 as well the piston bearing surfaces 166 of the bosses 156. In alternative embodiments, the lubrication ports may be formed in any size and/or shape, and in any fashion that creates fluid paths between the crankcase and the pin and piston bearing surfaces sufficient to permit adequate lubrication of these surfaces using mineral oil or other lubricants.

Referring again to FIGS. 1 and 2, the connections between the connecting arm 108, the pin 110 and the piston 112 are explained in more detail. When fully assembled, the components of the compressor 100 are arranged so that the pin 110 acts as a dual bearing or redundant bearing. As most clearly shown in FIG. 2, the arm 108, the pin 110 and the piston 112 are assembled by first placing the pin ring 132 of the arm 108 in a position substantially within the piston 112, between the bosses 156, and coaxially aligned with the pin axis of rotation 158. In this embodiment, two thin and substantially flat shims 170 are shown located coaxial to the pin axis of rotation 158, with one shim 170 between each side of the pin ring 132 and the adjacent bosses 156. The shims 170 serve to reduce wear of the bosses 156 and the pin ring 132 as the pin ring 132 moves relative to the bosses 156. However, in alternative embodiments, shims may be omitted or replaced by other suitable devices for reducing wear of the components. Once the shims 170 and the pin ring 132 are substantially located within the piston 112 and coaxial with the pin axis of rotation 158, an end of the pin 110 is inserted through a pin aperture 154 in the nearest adjacent boss 156, through the nearest adjacent shim 170, through the pin ring 132, through the remaining shim 170 and through the remaining boss 156. The pin 110 is ultimately positioned so that the outermost extending portions of the endcaps 145 extend substantially to the outer surface 146 of the piston 112 at both ends of the pin 110. This arrangement provides a dual bearing or redundant bearing feature in that the pin 110 is free to rotate about the pin axis of rotation 158 relative to each of the piston 112 and the pin ring 132. In an alternative embodiment of a compressor, the pin may not serve as a redundant bearing as described above, but rather, the pin may only serve to rotate relative to the piston. More specifically, in that alternative embodiment, the pin may be substantially rigidly fixed to the rod by press fitting the pin into the pin ring, by application of thermal heat shrink to secure the pin relative to the rod, through the use of a mechanical fastening device, or any other suitable device or system for reducing relative rotation of the pin relative to the rod, namely, the relative rotation between the pin bearing surface and the pin ring bearing surface.

Referring again to FIG. 1, the operation of the compressor is now explained. Generally, lubricant (not shown) pools near the lower bearing 122 and remains accumulated to a level substantially near the interface of the lower shank 120 and the transition shank 128. Compressor 100 functionality begins when the motor 104 is energized resulting in the armature 116 exerting a rotational force on the crankshaft 106. Since the armature 116 and the lower bearing 122 allow rotation of the crankshaft 106 about the axis of rotation 126, the upper shank 114 and lower shank 120 rotate about the axis of rotation 126 while the transition shank 128 rotates in a circular orbit about the axis of rotation 126. Since the connecting arm 108 is connected to the transition shank 128 via the shaft ring 130, the arm 108 is carried by the transition shank 128 in the same orbital path, and the transition shank 128 simultaneously rotates within the shaft ring 130. Since the shaft ring 130 is rigidly attached to the pin ring 132 via the bridge 136, and the pin ring 132 is connected to the piston 112 via the pin 110, the entire arm 108 is reciprocated along the central axis of the cylindrical bore 133 in which the piston 112 is housed. Necessarily, the piston 112 follows the movement of the arm 108 in that the piston 112 is resultantly reciprocated within the bore 133 toward and away from the crankcase 134.

During such reciprocation and movement of the above-described components, the pin 110 is free to rotate about the pin axis of rotation 158, and the rotation may be relative to one or both of the pin ring 132 and the bosses 156. More specifically, the pin bearing surface 142 of the pin 110 is not only free to rotate relative to the pin ring bearing surface 140 of the pin ring 132, but also relative to the piston bearing surfaces 166 of the bosses 156. During rotation of the crankshaft 106, a centrifugal pump (not shown) pumps lubricant from the above-described pooled lubricant and through the lower lubricant delivery aperture 135 of the lower shank 120 of the crankshaft 106. In an embodiment, the crankshaft 106 is rotated at approximately 3500 RPM, although in alternative embodiments, the crankshaft may be rotated at higher or lower speeds or may even be operated at varying speeds. As the lubricant exits the lower lubrication delivery aperture 135 near the interface of the lower shank 120 and the transition shank 128, the rotation of the crankshaft 106 cause the lubricant to be splashed all about within the crankcase 134. Lubricant is also passed through the crankshaft 106 so that it exits the upper shank 114 through two upper lubrication delivery apertures 139. The upper lubrication delivery apertures 139 are positioned along the length of the upper shank 114 so that they are aligned with and generally encircled by the upper bearing 123. When lubricant exits the upper lubrication delivery apertures 139, the interface between the upper shank 114 and the upper bearing 123 is lubricated. Further, the lubricant subsequently exits the space between the upper shank 114 and the upper bearing 123 at the bottom end of the upper bearing 123 and enters the crankcase 134 to thereafter be splashed all about within the crankcase 134 as described above. A lubricant delivery aperture substantially similar to the upper lubrication delivery aperture 139 is formed in the transition shank 128 and similarly lubricates the interface between the eccentric bearing surface 129 and the shaft ring bearing surface 138. The lubricant subsequently exits the space between the eccentric bearing surface 129 and the shaft ring bearing surface 138 at both the top and bottom ends of the shaft ring bearing surface 138 and enters the crankcase 134 to thereafter be splashed all about within the crankcase 134 as described above. The splashed lubricant may be struck again by the rotating and translating components of the compressor 100 within the crankcase 134. This process of splashing and striking the lubricant often forms a mist or fog of lubricant within the crankcase 134 that generally lubricates all surfaces that come in contact with the mist or fog.

However, in an embodiment, at least some of the splashed and stricken lubricant is directed or deflected to have a trajectory that terminates within or through the lubrication ports 168. The lubricant that reaches the lubrication ports 168, or is passed through the lubrication ports 168, directly aids in lubricating the interface between the pin bearing surface 142 and the piston bearing surface 166. In an embodiment, some of the lubricant directly strikes the pin bearing surface 142 by passing through the lubrication ports 168.

To maximize the amount of pin bearing surface 142 exposed to direct lubrication through the lubrication ports 168, the size of the lubrication ports 168 may be maximized until enlarging the lubrication ports 168 any more would unduly compromise the strength of the bosses 156. In particular, the piston 112 must be able to withstand the forces exerted on it by the pin 110 to push it away from and pull it towards the crankcase 134. In an embodiment, the force exerted on the piston 112 by the pin 110 to pull the piston 112 toward the crankcase 134 is only about 10% of the force exerted on the piston 112 by the pin 110 to push the piston 112 away from the crankcase 134. Accordingly, those force differentials must be considered when maximizing the size of the lubrication ports.

As evinced by the discussion above, the compressor 100 employing improved lubrication features and methods, and the alternative embodiments disclosed, provide the ability to adequately lubricate the interface between a pin and a piston when that pin is used to connect an arm to the piston. The improved lubrication of the interface between the pin and the piston results from the lubrication ports associated with the bosses since the lubrication ports offer unimpeded access for the lubricant to reach the pin through the lubrication ports. Further, such adequate lubrication is achieved by the above disclosed compressor embodiments even when the compressors use R-410A refrigerant and lubricants that do not splash as readily as mineral oil.

While various embodiments of compressors have been shown and described, modifications thereof can be made by one skilled in the art without departing from the spirit or teaching of this disclosure. The embodiments described herein are representative only and are not limiting. Many variations and modifications of the apparatus and methods are possible and are within the scope of the disclosure. Accordingly, the scope of protection is not limited to the embodiments described herein, but is only limited by the claims that follow, the scope of which shall include all equivalents of the subject matter of the claims.

What is claimed is:

1. A compressor for an air conditioning system, comprising:
a piston comprising:
an aperture forming a piston bearing surface; and
a lubrication port in communication with the aperture; and
a pin having a pin bearing surface, the pin being received within the aperture to form an interface between the pin bearing surface and the piston bearing surface.

2. The compressor according to claim 1, wherein the lubrication port is an aperture.

3. The compressor according to claim 1, wherein the lubrication port provides a fluid path to the interface between the pin bearing surface and the piston bearing surface.

4. The compressor according to claim 1, further comprising:
a crankcase;
wherein a fluid path exists between the lubrication port and the crankcase.

5. The compressor according to claim 1, wherein the aperture is formed radially through a wall of the piston.

6. The compressor according to claim 5, wherein the lubrication port is formed axially through a boss of the piston that extends inward from the wall of the piston.

7. The compressor according to claim 1, further comprising:
an arm connected to the piston via the pin.

8. The compressor according to claim 7, wherein the pin is rotatable relative to each of the piston and the arm.

9. The compressor according to claim 7, the arm comprising:
a pin ring through which the pin extends.

10. The compressor according to claim 9, wherein the pin ring comprises a pin ring bearing surface that forms an interface with the pin bearing surface.

11. A method of lubricating within a compressor, comprising:
rotating a crankshaft within a crankcase;
introducing lubricant into the crankcase; and
contacting the lubricant with a portion of a pin disposed within a piston via a lubrication port in the piston.

12. The method according to claim 11, wherein the introducing comprises pumping the lubricant into the crankcase.

13. The method according to claim 11, wherein the introducing comprises flowing the lubricant through a delivery aperture in the crankshaft.

14. The method according to claim 11, wherein the lubricant is chemically compatible with R-410A refrigerant.

15. The method according to claim 11, wherein the contacting is accomplished by striking the lubricant with a rotating component of the compressor.

16. A piston for a compressor, comprising:
an aperture forming a piston bearing surface; and
a lubrication port in communication with the aperture.

17. The piston according to claim 16, wherein the lubrication port is an aperture.

18. The piston according to claim 16, wherein the lubrication port provides a fluid path to the piston bearing surface.

19. The piston according to claim 16, further comprising:
an outer wall having an inner surface; and
a boss extending inward from the inner surface.

20. The piston according to claim 19, wherein the aperture and the lubrication port are both formed in the boss.
